(19) United States
(12) Patent Application Publication
(10) Pub. No.: US 2003/0111906 A1
(43) Pub. Date: Jun. 19, 2003

(54) Parallel parking aid

(76) Inventor: Malcolm Anton McManus Burke, Washington, DC (US)

Correspondence Address: MALCOLM A. BURKE, 1613 30TH ST. NW, APARTMENT 1N, WASHINGTON, DC, 20007, US

(21) Appl. No.: 10/017,623

(22) Filed: Dec. 15, 2001

(51) Int. Cl. B60Q 1/30

(52) U.S. Cl. 307/10.8

(57) ABSTRACT

The present invention provides a control system for activating and controlling the reverse gear indicator lights of a vehicle. This Parallel Parking Aid (PPA) will comprise a button, switch or other means of manual or sensate activation, whereby the reverse gear indicator lights of a vehicle may be engaged without the vehicle being engaged in the reverse gear, and by which those reverse gear indicator lights may be caused to flash or blink.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, ETC.

Not Applicable

### BACKGROUND OF THE INVENTION

The present invention relates to the reverse indicator lights typically used when a motor vehicle is engaged in reverse gear. More particularly, the present invention relates to an apparatus for activating and controlling the reverse indicator lights on a vehicle so that they may be used for indicating anticipated reverse gear operation while the vehicle remains engaged in a forward or neutral gear.

It is common for motor vehicles, particularly automobiles, to signal the engagement of the vehicle's reverse gear by means of white light or lights at the rear of the vehicle. Present devices of operating these reverse gear indicator lights generally use mechanical relays or other conventional “hard-wired” circuitry that activate the reverse indicator lights only when the vehicle is actually engaged in reverse gear.

There are inherent disadvantages to a system of indicator light activation that does not allow for activation of the indicator light prior to the engagement of the vehicle in reverse gear. Specifically, the prior art creates a situation in which the operator of a vehicle, in traffic and attempting to parallel park, is unable to signal to the operators of vehicles behind him of his intention to pass an open parking space, place his or her vehicle in reverse, and enter the open parking space in reverse. Particularly in heavy traffic, it is the nature of mankind to operate their motor vehicles in as close proximity to one another as possible, in such a situation it is difficult to maintain sufficient space between vehicles to allow for the reverse operation into an available parking space. It is to this failure of the prior art to which the present invention is drawn.

### BRIEF SUMMARY OF THE INVENTION

The present invention provides a control system for activating and controlling the reverse gear indicator lights of a vehicle. The Parallel Parking Aid (PPA) will comprise a switch, button or other means of manual or sensate activation, whereby the reverse gear indicator lights of a vehicle may be engaged without the vehicle being engaged in the reverse gear.

This switch or other means of activation may comprise a means of regulating its activation, for example to allow the manual operation of the reverse gear indicator lights only when the vehicle is traveling below a preset speed, or perhaps only when the vehicle is traveling below a preset speed and a turn signal indictor is engaged. The advantage to this invention is that it allows for indication to the operators of motor vehicles behind the vehicle in which it is installed of an impending reverse operation.

Specifically, when the operator of a vehicle identifies an available parking space and wishes to communicate his intention to enter that parking space in reverse he may do so, prior to passing the open parking space. Previously, the operator would have already passed the open parking space before he could activate his reverse gear indicator lights by actually placing his or her vehicle in reverse.

### BRIEF DESCRIPTION OF THE SEVERAL VIEWS OF THE DRAWING

Not Applicable

### DETAILED DESCRIPTION OF THE INVENTION

The present means of operation of the reverse gear indicator lights allows only for operation thereof when the vehicle itself is engaged in reverse gear. This produces the obvious inadequacy of an indicator light, i.e.: that it indicates what will happen rather than what has already happened. This invention will consist of a button, switch, or other means of sensate activation that will allow the activation of the vehicle reverse gear indicator lights. If developed as a switch or button this invention would be placed ideally on the gearshift housing, within easy reach of the vehicles operator.

The button or switch, when manipulated into the on, or active position, will cause the reverse gear indicator lights of the vehicle to turn on. This is most easily performed by connecting the brake light power line to the vehicle's power supply. When the operator of the motor vehicle wishes to communicate his intention of parallel parking or the placing of his or her vehicle in reverse while still engaged in forward or neutral gear, he or she would manipulate the button or switch. This improvement allows for the indication to other vehicle operators of one's intent to engage in reverse vehicle operation.

The best mode of carrying out this invention is by the placement within the vehicle of a switch or button that allows the operator of that vehicle to engage the vehicle's reverse gear indicator lights. This button itself would indicate, by either its position or by internal illumination that the reverse gear indicator lights were engaged.

The best mode would also allow for use of this invention only when the vehicle was operating at less than six (6) miles per hour. Such a limit would prevent the accidental activation of the reverse gear indicator lights at higher speeds.

I claim:

1. A switching system within a motor vehicle comprising: a means for activating the reverse gear indicator lights (traditionally the white lights on the rear of a vehicle), wherein the switching system includes: first, a means for activating the reverse gear indicator lights while the vehicle is engaged in a forward gear or in neutral by means of a button or switch or other means of sensate activation; and second, a means of causing the reverse gear indicator lights, by means of a button or switch or other means of sensate activation, to flash or blink after having been activated.

2. The switching system as in claim 1, wherein: the switching means is operable only when: third, the vehicle is being operated at a speed of less than 6 mph, or some other predetermined speed.

3. The switching system as in claim 1, wherein: the switching means is operable only when: third, the vehicle is being operated at a speed of less than 6 mph, or some other predetermined speed, and; fourth when a turn signal indicator switch of the vehicle has been activated.

4. Circuitry whereby the activation of the button, switch or other means of sensate activation, a second time, described in claim 1, within a predetermined period of time will cause the reverse gear indicator lights of the vehicle to blink or flash.
